(19) United States
(12) Patent Application Publication
(10) Pub. No.: US 2008/0018743 A1
(43) Pub. Date: Jan. 24, 2008

(54) Image data processing system and method thereof

(75) Inventors: Sang-Wook Oh, Ansan-si (KR); Sung-Dae Cho, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/880,660

(22) Filed: Jul. 24, 2007

(30) Foreign Application Priority Data
Jul. 24, 2006 (KR) 69279/2006

(51) Int. Cl. H04N 5/225

(52) U.S. Cl. 348/207.1

(57) ABSTRACT

A system for processing image data includes a portable terminal for generating raw data and preview data by converting an optical signal of an image captured using a camera to a digital signal, compressing and storing the raw data and the preview data, generating an image file, and transmitting the image file to the outside, and an external image display device for receiving the image file from the portable terminal, separating raw data and preview data from the image file, decompressing the raw data, performing image processing of the decompressed raw data, and displaying the image-processed raw data.

### CLAIM OF PRIORITY

This application claims the benefit of the earlier filing date, under 35 U.S.C. §119(a), to that patent application filed in the Korean Intellectual Property Office on Jul. 24, 2006 and assigned Serial No. 2006-69279, the contents of which are incorporated herein by reference.

### BACKGROUND OF THE INVENTION

1. Field of the Invention

The present invention relates generally to an image data processing system, and in particular, to an image data processing system for increasing the performance of an image processing function.

2. Description of the Related Art

The brisk progress of digital signal processing technology results in developing and realizing various functions in an image capturing device field such as a digital camera. Since image capturing devices, such as a digital camera, can easily acquire an image signal, such an image capturing device is stealing the spotlight as an image input unit in personal computers (PCs) or similar image processing systems.

FIG. 1 is a block diagram of a general digital camera.

Referring to FIG. 1, the general digital camera includes a lens module 110, a Charge Coupled Device (CCD) 120, which is a solid state pickup device, a Digital Camera Processor (DCP) 130, a controller 140, a storage unit 150, and a timing generator 160.

The CCD 120 includes light-receiving pixels for receiving light, converting the light to electronic charges, and accumulating the electronic charges and a transmission channel for receiving the electronic charges accumulated by the light-receiving pixels and transmitting them via an output terminal. The light-receiving pixels include photodiodes equipped with an RGB color filter. The CCD 120 also includes an electronic shutter for controlling exposure by momentarily removing the electronic charges accumulated by the light-receiving pixels

An operation of the general digital camera will now be described. Light reflected by an object reaches on the CCD 120 via the lens module 110, and the CCD 120 opto-electrically converts the light to a signal using the photodiodes and outputs the signal to the DCP 130.

The DCP 130 performs various processes with respect to the signal input from the CCD 120. For example, the DCP 130 performs various processes related to image quality, such as gamma correction of luminance, edge enhancement, luminance control, and color calibration, with respect to the signal input from the CCD 120, converts the signal to an image signal, such as a National Television Standards Committee (NTSC) signal, and outputs the image signal. The processed signals are temporarily stored in the storage unit 150, e.g., a frame memory for storing data on a frame basis or a storage medium for storing image data compressed in a Joint Photographic Experts Group (JPEG) format.

The DCP 130 outputs specific information, e.g., luminance information, to the controller 140 while processing the input signal, and the controller 140 controls the storage unit 150 and the timing generator 160 using the specific information input from the DCP 130.

The timing generator 160 generates a timing signal for controlling the electronic shutter of the CCD 120.

Recently, portable terminals having an image capturing function of the digital camera described above have been available on the market, and functions of the portable terminals are extending to a multimedia function and a high-resolution digital camera function by overcoming the conventional call-oriented mobile communication concept.

That is, accompanying an increase of the demand of consumers and an expansion of application range, development of a high-performance digital camera becomes a very important issue for a competitive portable terminal on the global market.

A user of a portable terminal equipped with an image capturing device can capture various images using the portable terminal, wherein the captured images are used for a background image of the portable terminal or a photo mail or edited using an image editing program of a PC and used.

However, unlike a general digital camera, an image capturing device equipped in the portable terminal has a physical characteristic of having a very small volume. Thus, components, such as a camera, equipped in the portable terminal must be integrated in a small space and consume low power due to the use of a secondary battery. Thus, it is difficult for an image processing unit of the portable terminal to use an algorithm having the best performance and a large computation capacity due to cost limitation and physical limitation of space and power.

An image processing function of the image processing unit significantly affects quality of an image captured by the camera. Thus, if an image is captured using the camera of the portable terminal, image quality is generally lower than that of a general digital camera.

In addition, since the portable terminal has a small-sized display unit for displaying an image, when an image of more than million pixels is displayed, it is difficult to determine whether the image is captured well, and the user can perceive only what image is captured. Thus, when image data captured by the camera of the portable terminal stored in the portable terminal, image processing of the image data does not have to be performed in advance.

### SUMMARY OF THE INVENTION

An aspect of the present invention is to substantially solve at least the above problems and/or disadvantages and to provide at least the advantages below. Accordingly, an aspect of the present invention is to provide an image data processing system for performing an image processing function of high performance by generating raw data and preview data by converting an optical signal of an image captured using a camera equipped in a portable terminal to a digital signal, generating an image file, transmitting the image file to an external image display device, and performing image processing of the image file using an image processing unit included in the external image display device, and a method thereof.

According to one aspect of the present invention, there is provided a system for processing image data, the system comprising a portable terminal for generating raw data and preview data by converting an optical signal of an image captured using a camera to a digital signal, compressing and storing the raw data and the preview data, generating an image file, which is to be output to the outside, using the stored raw data and preview data, and transmitting the image file to the outside and an external image display device for receiving the image file from the portable terminal, separating raw data and preview data from the image file, decompressing the raw data, performing image processing of the decompressed raw data, and displaying the image-processed raw data.

### BRIEF DESCRIPTION OF THE DRAWINGS

The above features and advantages of the present invention will become more apparent from the following detailed description when taken in conjunction with the accompanying drawing in which:

FIG. 1 is a block diagram of a general digital camera;

FIG. 2 illustrates an image data processing system according to an exemplary embodiment of the present invention;

FIG. 3 is a flowchart illustrating a process of processing image data in an image data processing system according to an exemplary embodiment of the present invention;

FIG. 4 is a block diagram of a portable terminal according to an exemplary embodiment of the present invention;

FIG. 5 is a block diagram of a camera module illustrated in FIG. 4, according to an exemplary embodiment of the present invention;

FIG. 6 illustrates an image file according to an exemplary embodiment of the present invention; and

FIGS. 7A and 7B respectively illustrate a screen of a portable terminal and a screen of an external image display device, which are included in an image data processing system according to an exemplary embodiment of the present invention.

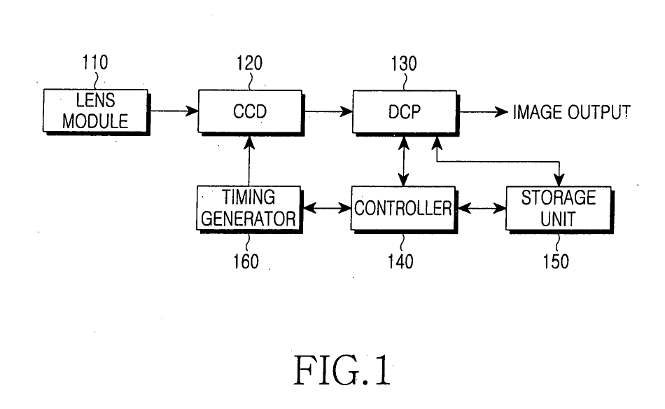

### DETAILED DESCRIPTION OF THE INVENTION

Embodiments of the present invention are described herein with reference to the accompanying drawings. For the purposes of clarity and simplicity, well-known functions or constructions are not described in detail as they would obscure the invention in unnecessary detail.

Prior to the description of the embodiments of the present invention, a portable terminal according to an exemplary embodiment of the present invention may be a Personal Digital Assistant (PDA), a smart phone, a Portable Multimedia Player (PMP), or a mobile communication terminal or similar devices. An external image display device according to an exemplary embodiment of the present invention may be a Personal Computer (PC) or TV, which can display image data and multimedia data.

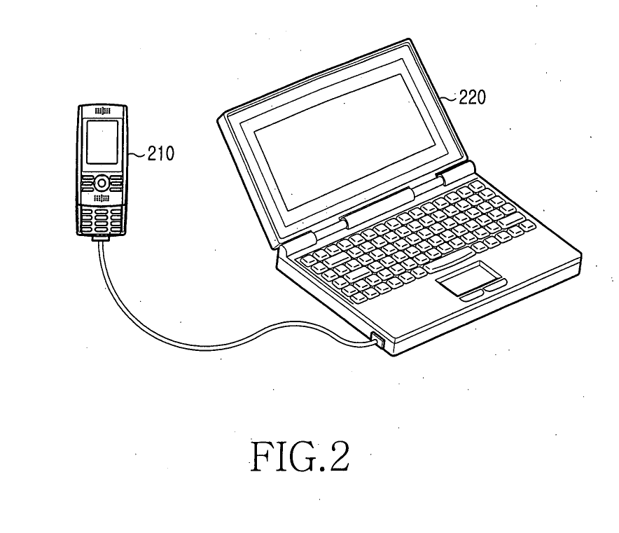

FIG. 2 illustrates an image data processing system according to an exemplary embodiment of the present invention.

Referring to FIG. 2, the image data processing system includes a portable terminal 210 and an external image display device 220.

The portable terminal 210 and the external image display device 220 are connected via cable to transmit and receive an image file. In the current embodiment, the portable terminal 210 and the external image display device 220 are connected via cable by having a wired module, preferably a 3.5 Φ Audio/Video (A/V) cable and a Universal Serial Bus (USB) port. However, it would be recognized that other types of connections may be utilized (e.g., serial, parallel, Ethernet, etc.)

However, it will be understood by those skilled in the art based on the present specification that the portable terminal 210 and the external image display device 220 may be connected in a wireless manner by having a wireless module (not shown) of a short-distance wireless communication method, such as Bluetooth, Infrared Data Association (IrDA), Wireless Local Area Network (WLAN), or Shared Wireless Access Protocol (SWAP). If a wireless module of a short-distance wireless communication method is prepared, the portable terminal 210 transforms a format of the image file according to the prepared short-distance wireless communication method and transmits it to the external image display device 220 in the wireless manner.

Since Bluetooth, IrDA, WLAN, and SWAP, which are well-known short-distance wireless communication methods, detailed description of such technology need not be discussed in detail herein.

Returning to FIG. 2, the portable terminal 210 captures an image using a camera equipped therein and generates raw data and preview data by converting an optical signal of the captured image to a digital signal. In order to reduce the amount of the raw data and the preview data, the portable terminal 210 compresses and stores the raw data and the preview data. Thereafter, in response to a request signal input by a user, the portable terminal 210 displays the preview data on a display unit thereof, or generates an image file using the raw data and the preview data and transmits the image file to external image display device 220, in this illustrated case, via cable.

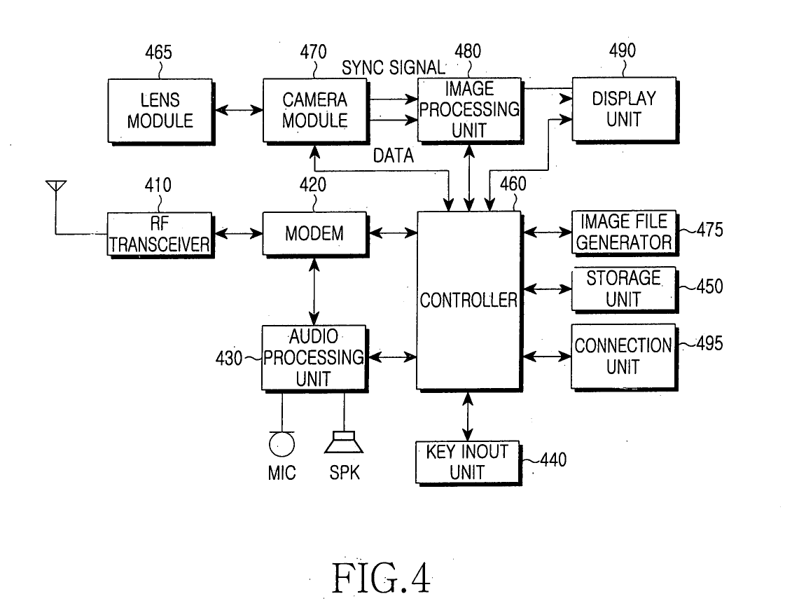

The portable terminal 210 is further described in more detail with reference to FIG. 4.

The external image display device 220 receives the image file from the portable terminal 210, separates raw data and preview data from the image file, and decompresses the raw data. Here, the external image display device 220 may store the preview data for fast display according to a user's selection or may delete the preview data.

After decompressing the raw data, the external image display device 220 performs image processing of the decompressed raw data and displays the image-processed raw data on a display unit thereof.

As described above, instead of performing image processing of image data captured by the camera of the portable terminal 210 using an image processing unit of the portable terminal 210, by transmitting the image data to the external image display device 220 and performing image processing of the image data using an image processing unit of the external image display device 220, the image data processing system can use a high-performance image processing algorithm.

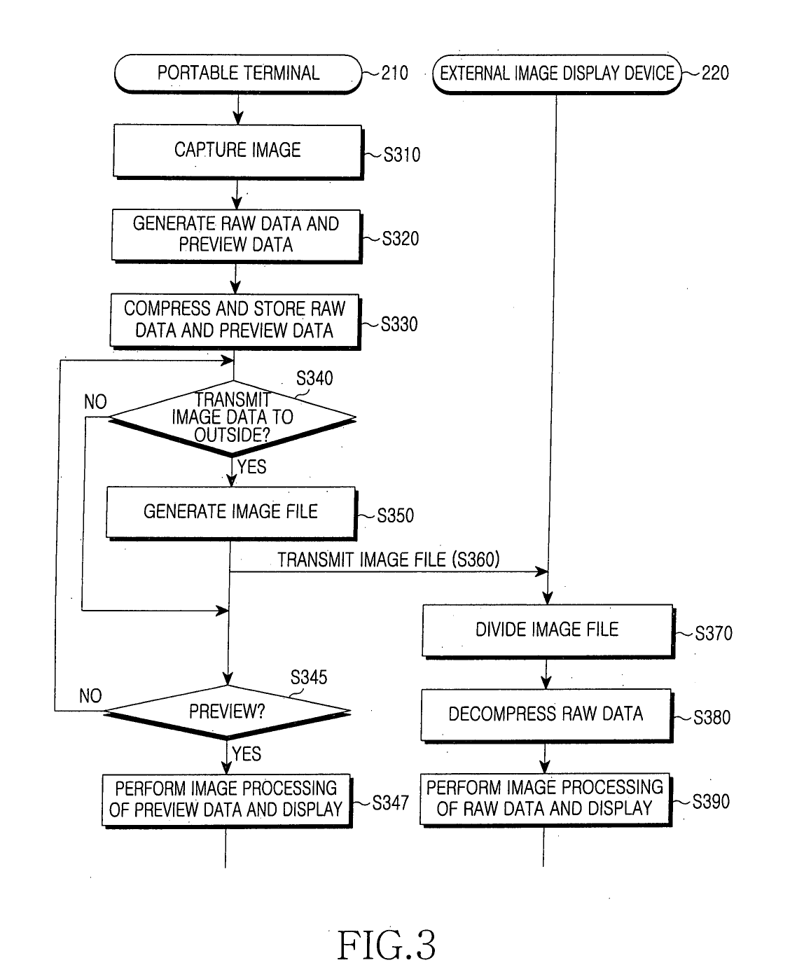

A process of processing image data in the image data processing system will now be described in more detail with reference to FIG. 3.

FIG. 3 is a flowchart illustrating a process of processing image data in the image data processing system illustrated in FIG. 2 according to an exemplary embodiment of the present invention.

Referring to FIG. 3, when a signal for image capture is received, the portable terminal 210 is changed to an image capture mode and captures an image in step S310. When the image is captured, the portable terminal 210 generates raw data and preview data in step S320 by converting an optical signal of the captured image to a digital signal. The raw data and the preview data are generated by a camera module of the portable terminal 210. The camera module captures an image and converts an optical signal of the captured image to a digital signal. The optical signal converted to the digital signal becomes preferably Bayer format data, and the Bayer format data is the raw data of the captured image. The preview data is generated by sub-sampling the raw data by an amount of data required to display the captured image on the display unit of the portable terminal 210. Although, Bayer format is referred-to, it would be recognized that any of a plurality of known formats may be used to store the captured raw data.

After generating the raw data and the preview data, the portable terminal 210 compresses and stores the raw data and the preview data in step S330 in order to reduce a data amount. In the current embodiment described herein, the raw data is losslessly compressed, and the preview data is lossy compressed.

In general, loss compression is compression of a case where data obtained by compressing original data and decompressing the compressed data is not completely equal to the original data. For example, even if data, such as a picture, a moving picture, or voice, is not completely equal to original data, the data is available, and thus, for the data, the loss compression having a high compression ratio with some loss is mainly used. On the contrary, in a case of font data used with text data, if even a little loss of the font data occurs, the loss affects perceiving the original data, and compressing the font data will be worse than using the original data as it is. Thus, in this case, lossless compression having a low compression ratio without loss is mainly used.

In the current embodiment, the preview data is compressed in a loss compression method, e.g., a JPEG loss compression method. The raw data is divided according to R (red), G (green), and B (blue) color channels and compressed in a lossless compression method using correlations between the color channels. In the current embodiment, a 3-dimension (3D) wavelet compression method is used as the lossless compression method. However, the methods of compressing the raw data and the preview data, which are used in the current embodiment, are not limited thereto, and generally other image compression methods can be used.

Thereafter, when a signal for transmitting data of the captured image to the outside is input by the user in step S340, the portable terminal 210 generates an image file, which is to be transmitted externally in step S350. The image file contains at least the stored raw data and may also include the preview data. The image file may be generated with both the raw data and the preview data or with only the raw data according to settings of the user or a manufacturer of the portable terminal 210.

After generating the image file, the portable terminal 210 transmits the image file to the external image display device 220 in step S360.

When the image file is received from the portable terminal 210, the external image display device 220 separates raw data and preview data from the image file in step S370. That is, if a file is received from the portable terminal 210, the external image display device 220 can determine by checking a header field of the file whether the file is an image file, and if it is determined that the file is an image file, the external image display device 220 separates raw data and preview data from the image file. Here, the external image display device 220 may store the preview data for fast display in the future according to a user's selection or delete the preview data.

After separating the raw data and the preview data from the image file, the external image display device 220 decompresses the raw data in step S380. The external image display device 220 performs image processing of the decompressed raw data and displays it on the display unit thereof in step S390.

If a signal for previewing the captured image is input by the user in step S345, the portable terminal 210 decompresses the stored preview data, performs image processing of the decompressed preview data using the image processing unit of the portable terminal 210 and displays it on a display unit thereof in step S347.

FIG. 4 is a block diagram of the portable terminal 210 illustrated in FIG. 2, according to an exemplary embodiment of the present invention.

Referring to FIG. 4, the portable terminal 210 includes a Radio Frequency (RF) transceiver 410, a modem 420, an audio processing unit 430, a key input unit 440, a storage unit 450, a controller 460, a lens module 465, a camera module 470, an image file generator 475, an image processing unit 480, a display unit 490, and a connection unit 495.

In more detail, the RF transceiver 410 transmits and receives voice data, Short Message Service (SMS) data, image data, and control data under the control of the controller 460 and includes an RF transmitter (not shown) for up-converting a frequency of a transmission signal and amplifying the transmission signal and an RF receiver (not shown) for low-noise amplifying a reception signal and down-converting a frequency of the reception signal.

The modem 420 includes a transmitter (not shown) for encoding and modulating a signal to be transmitted by the RF transceiver 410 and a receiver (not shown) for demodulating and decoding a signal input from the RF transceiver 410

The audio processing unit 430 can include a codec, which includes an audio codec (not shown) for processing packet data and the like and a data codec (not shown) for processing an audio signal such as voice. The audio processing unit 430 modulates and converts an electrical signal input from a microphone MIC to voice data, and demodulates encoded voice data input from the RF transceiver 410 to an electrical signal and outputs the electrical signal to a speaker SPK. The audio processing unit 430 preferably includes a codec for converting a digital audio signal received from the RF transceiver 410 to an analog audio signal and reproducing the analog audio signal, or converting an analog audio signal input from the microphone MIC to a digital audio signal. The codec may be included in the controller 460.

The key input unit 440 has a key-matrix structure (not shown), includes character keys, number keys, various kinds of function keys, and external volume keys, and outputs a key input signal corresponding to a key selected by a user to the controller 460. The key input unit 440 may further include an image data processing key according to an exemplary embodiment of the present invention.

The storage unit 450 can include a program memory, a data memory, and the like and stores various kinds of information required for operation control of the portable terminal 210 according to an exemplary embodiment of the present invention and various kinds of information selected based on user's selection information. The storage unit 450 also stores raw data and preview data generated by the camera module 470.

The controller 460 controls a general operation of the portable terminal 210 according to an exemplary embodiment of the present invention. If a signal for capturing an image is input from the key input unit 440, the controller 460 controls the camera module 470 to change to the image capture mode for image capture. In the image capture mode, if a shutter key signal for capturing an image is input from the key input unit 440, the controller 460 controls the camera module 470 to capture an image. If raw data and preview data compressed in respective compression methods are input from the camera module 470, the controller 460 stores the compressed raw data and preview data in the storage unit 450.

Thereafter, if a signal for transmitting data of a captured image to the outside is input from the key input unit 440, the controller 460 transmits the raw data and the preview data stored in the storage unit 450 to the image file generator 475 and controls the image file generator 475 to generate an image file. If the image file is generated by the image file generator 475, the controller 460 transmits the image file to the connection unit 495 and controls the connection unit 495 to transmit the image file to the outside.

If a signal for previewing data of a captured image is input from the key input unit 440, the controller 460 transmits the preview data stored in the storage unit 450 to the image processing unit 480 and controls the image processing unit 480 to perform image processing of the preview data and display a preview image on the display unit 490.

The camera module 470 includes the lens module 465, which can be pulled out and retracted, and captures an image by means of the lens module 465. The camera module 470 generates raw data and preview data by converting an optical signal of the captured image to a digital signal under the control of the controller 460, compresses the raw data and the preview data in respective compression methods, and transmits the compressed raw data and preview data to the controller 460. A configuration of the camera module 470 will be described in more detail with reference to FIG. 5.

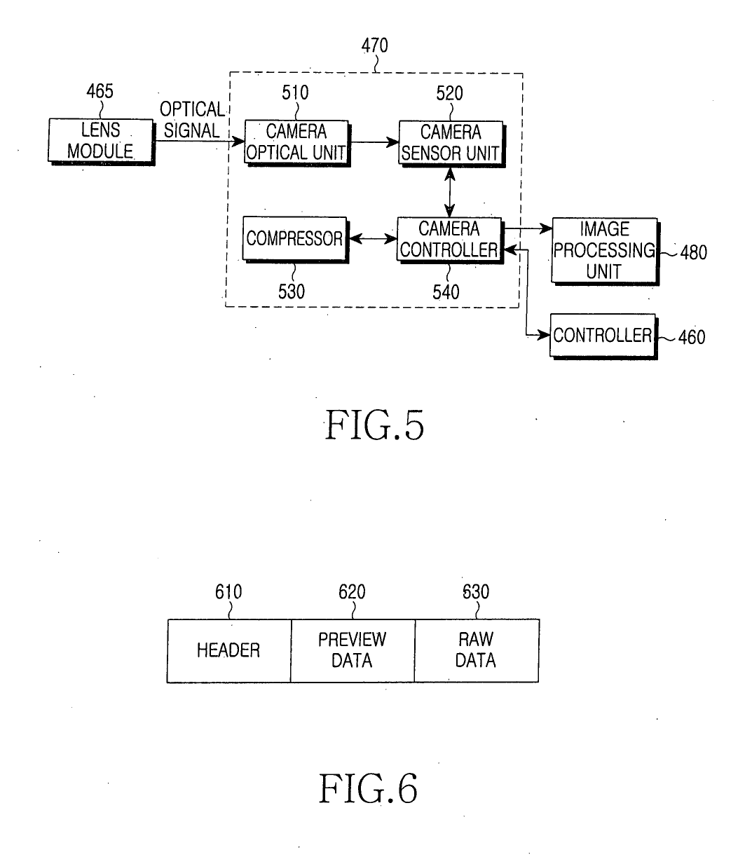

The image file generator 475 receives raw data and preview data from the controller 460, generates an image file, which is to be transmitted to the outside, using the raw data and the preview data, and transmits the image file to the controller 460. The image file includes a header field indicating file information, a preview field, and a raw data field. The image file will be described in more detail with reference to FIG. 6.

The image processing unit 480 generally performs a function of generating screen data for displaying image data input from the camera module 470. In the current embodiment, the image processing unit 480 receives preview data from the controller 460, decompresses the preview data, performs image processing of the decompressed preview data, and transmits it to the display unit 490.

The display unit 490 can include a Liquid Crystal Display (LCD) and displays various kinds display data generated by the portable terminal 210. When the LCD is implemented in a touch screen method, the display unit 490 may operate as an input unit. In the current embodiment, the display unit 490 receives preview data image-processed by the image processing unit 480 and displays it as a preview image.

The connection unit 495 connects the portable terminal 210 and the external image display device 220. In the current embodiment, the connection unit 495 includes a wired module for receiving wired cables, such as a 3.5 Φ A/V cable and a USB cable, to transmit and receive an image file with the external image display device 220. In addition, it will be understood by those skilled in the art that the connection unit 495 can include a module of a short-distance wireless communication method, such as Bluetooth, IrDA, WLAN, or SWAP, to communicate with the external image display device 220 in a wireless manner.

FIG. 5 is a block diagram of the camera module 470 illustrated in FIG. 4, according to an exemplary embodiment of the present invention.

Referring to FIG. 5, the camera module 470 of the portable terminal 210 according to an exemplary embodiment of the present invention includes a camera optical unit 510, a camera sensor unit 520, a compressor 530, and a camera controller 540.

In more detail, if an optical signal of a captured image is input from the lens module 465, the camera optical unit 510 transmits the optical signal to the camera sensor unit 520.

If the optical signal is input from the camera optical unit 510, the camera sensor unit 520 converts the optical signal to a digital signal. The optical signal converted to the digital signal becomes Bayer format data, and the Bayer format data is raw data of the captured image. The camera controller 540 controls the camera sensor unit 520 to generate preview data by sub-sampling the raw data by an amount of data required to display the captured image on the display unit 490 of the portable terminal 210.

The camera sensor unit 520 transmits the raw data and the preview data to the camera controller 540.

The compressor 530 receives the raw data and the preview data from the camera controller 540, compresses the raw data and the preview data in respective compression methods in order to reduce an amount of the raw data and the preview data, and transmits the compressed raw data and preview data to the camera controller 540. In the current embodiment, the preview data is compressed using a loss compression method e.g., JPEG loss compression method. The raw data is divided according to R (red), G (green), and B (blue) color channels and compressed in a lossless compression method using correlations between the color channels. In the current embodiment, the lossless compression method is a 3D wavelet compression method. The camera controller 540 controls the camera sensor unit 520 to generate preview data by sub-sampling the raw data by an amount of data required to display the captured image on the display unit 490 of the portable terminal 210. If the raw data and the preview data are generated, the camera controller 540 transmits the raw data and the preview data to the compressor 530 in order to reduce the amount of the raw data and the preview data. The camera controller 540 receives the raw data and the preview data compressed in the respective compression methods from the compressor 530 and transmits them to the controller 460 of the portable terminal 210.

FIG. 6 illustrates an image file according to an exemplary embodiment of the present invention.

Referring to FIG. 6, the image file includes a header field 610 for storing information on the image file, a preview data field 620 for storing preview data, and a raw data field 630 for storing raw data.

The header field 610 stores information on the image file. The information on the image file contains information indicating that a current file is an image file, a total size of the image file, the size of preview data, and the size of raw data. Compressed preview data and compressed raw data are respectively stored in the preview data field 620 and the raw data field 630.

The image file may be generated with both the raw data and the preview data or with only the raw data according to settings of a user or a portable terminal manufacturer.

In the current embodiment, when a file is input, the external image display device 220 determines by checking the header field 610 of the input file whether the input file is an image file. The external image display device 220 separates raw data and preview data from the image file. The external image display device 220 decompresses the raw data, performs image processing of the decompressed raw data, and displays it. Here, the external image display device 220 may store the preview data for fast display in the future according to a user's selection or delete the preview data.

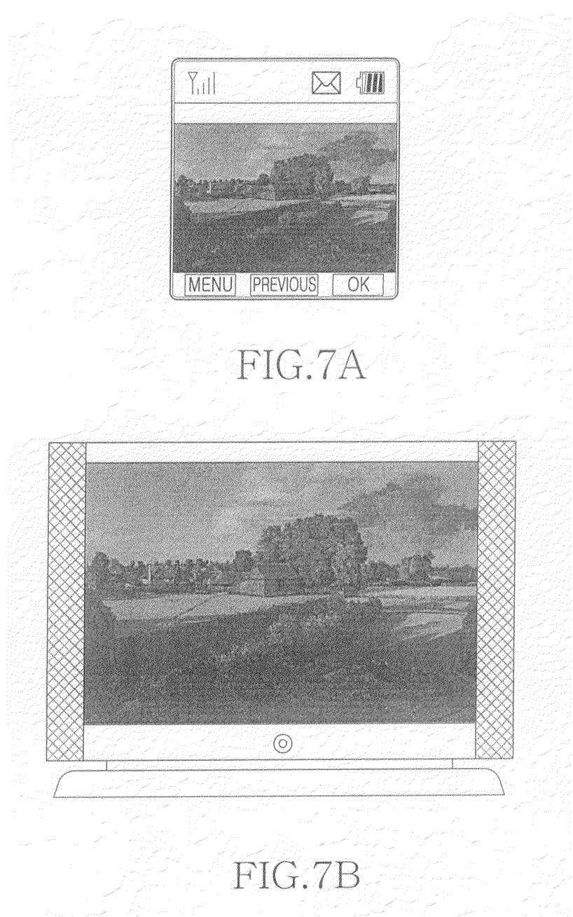

FIGS. 7A and 7B respectively illustrate a screen of a portable terminal and a screen of an external image display device, which are included in an image data processing system according to an exemplary embodiment of the present invention.

FIG. 7A illustrates a screen displayed as a preview image by the portable terminal 210 according to an exemplary embodiment of the present invention performing image processing of preview data using the image processing unit 480 of the portable terminal 210.

The preview image illustrated in FIG. 7A is preview data generated by sub-sampling raw data of an image captured by the camera module 470 by an amount of data required to display the captured image on the display unit 490 of the portable terminal 210.

When a signal for previewing the captured image is input by a user, the controller 460 of the portable terminal 210 transmits compressed and stored preview data to the image processing unit 480. The image processing unit 480 decompresses the received preview data and converts the decompressed preview data to image data having RGB color information per pixel by means of color interpolation.

The controller 460 of the portable terminal 210 displays the preview image illustrated in FIG. 7A by transmitting the image data to the display unit 490. The preview image displayed on the display unit 490 of the portable terminal 210 has lower image quality than an image captured by a camera of a general portable terminal. The user of the portable terminal 210 can check a state, a shape, and the contents of a currently captured image by viewing the preview image displayed on the display unit 490.

FIG. 7B illustrates a screen displayed by the external image display device 220 performing image processing of raw data using the image processing unit of the external image display device 220.

When an image file is input from the portable terminal 210, the external image display device 220 reads a header file of the image file and separates raw data and preview data from the image file. The external image display device 220 decompresses the raw data, performs image processing of the decompressed raw data using the image processing unit of the external image display device 220, and displays the image-processed raw data on the display unit of the external image display device 220.

Since the image processing unit of the external image display device 220 performs image processing with a higher performance, such as color interpolation and white balance, than the image processing unit 480 of the portable terminal 210, the external image display device 220 can display an image having higher quality than an image displayed by a general portable terminal.

Since it will be understood by those skilled in the art that various changes in form and details may be made therein without departing from the spirit and scope of the invention, the embodiments described above and accompanying drawings are not limited thereto.

As described above, according to the present invention, by generating raw data and preview data by converting an optical signal of an image captured by a camera equipped in a portable terminal to a digital signal, generating an image file, which is to be transmitted to an external image display device, using the raw data and the preview data, transmitting the image file to the external image display device, and performing image processing of the image file in external image display device, a high-performance image processing function can be performed.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A system for processing image data, the system comprising:
a portable terminal for generating raw data and preview data by converting an optical signal of an image captured using a camera to a digital signal, compressing and storing the raw data and the preview data, generating an image file, using the stored raw data and preview data, and transmitting the image file to the outside; and
an external image display device for receiving the image file from the portable terminal, separating raw data and preview data from the image file, decompressing the raw data, performing image processing of the decompressed raw data, and displaying the image-processed raw data.

2. The system of claim 1, wherein the preview data is generated by sub-sampling the raw data by an amount of data required to display the captured image on a display unit of the portable terminal.

3. The system of claim 1, wherein the raw data is losslessly compressed, and the preview data is lossy compressed.

4. The system of claim 1, wherein the image file is generated from data selected from the group consisting of: raw data and preview data.

5. The system of claim 4, wherein the image file comprises a header field for storing information on the image file, a preview data field for storing preview data, and a raw data field for storing raw data.

6. The system of claim 5, wherein the information on the image file contains information indicating that a current file is an image file, a total size of the image file, the size of the stored preview data, and the size of the stored raw data.

7. The system of claim 1, wherein the portable terminal and the external image display device comprise a module using a cable or a short-distance wireless communication method and are connected using the cable or the short-distance wireless communication method.

8. The system of claim 1, wherein the portable terminal is selected from the group consisting of: a Personal Digital Assistant (PDA), a smart phone, a Portable Multimedia Player (PMP), a mobile communication terminal.

9. The system of claim 1, wherein the external image display device is selected from the group consisting of: a Personal Computer (PC), and a TV.

10. A method of processing image data in an image data processing system, the method comprising:
capturing an image using a camera of a portable terminal;
generating raw data and preview data by converting an optical signal of the captured image to a digital signal and compressing and storing the raw data and the preview data;
transmitting raw data and preview data of the captured image as an image file to an external image display device; and
receiving the image file from the portable terminal, separating raw data and preview data from the image file, decompressing the separated raw data, performing image processing of the decompressed raw data, and displaying the image-processed raw data.

11. The method of claim 10, further comprising:
when a request signal for previewing the data of the captured image is input, decompressing the stored preview data, performing image processing of the decompressed preview data using an image processing unit of the portable terminal, and displaying the image-processed preview data as a preview image.

12. The method of claim 10, wherein the separated preview data can be stored for fast display in the future or deleted.

13. A portable terminal of an image processing system, comprising:
a camera module for generating raw data and preview data by converting an optical signal of a captured image to a digital signal, and compressing the raw data and the preview data;
a storage unit for receiving the compressed raw data and preview data from the camera module and storing them;
an image file generator for receiving the raw data and the preview data and generating an image file;
a connection unit for transmitting the image file generated by the image file generator to the outside; and
a controller for controlling the image file generator to generate an image file from the raw data and preview data to the image file generator, and controlling the connection unit.

14. The portable terminal of claim 13, further comprising:
an image processing unit for receiving preview data from the controller, decompressing the preview data, and performing image processing of the decompressed preview data.

15. The portable terminal of claim 14, further comprising:
a display unit for receiving the image-processed preview data from the image processing unit and displaying it as a preview image

16. The portable terminal of claim 13, wherein the camera module comprises:
a camera optical unit for delivering an optical signal of a captured image;
a camera sensor unit for receiving the optical signal of the captured image from the camera optical unit and generating raw data and preview data by converting the optical signal to a digital signal;
a compressor for compressing the raw data and the preview data received from the camera sensor unit in order to reduce an amount of the raw data and the preview data; and
a camera controller for controlling the camera sensor unit to generate preview data by sub-sampling raw data by an amount of data required to display a captured image on the display unit of the portable terminal and controlling the compressor to reduce an amount of the raw data and the preview data by transmitting the raw data and the preview data to the compressor.

17. The portable terminal of claim 16, wherein the compressor performs lossless compression with respect to the raw data and performs loss compression with respect to the preview data.

18. The portable terminal of claim 13, wherein the image file generator generates an image file comprising a header field for storing information on the image file, a preview data field for storing preview data, and a raw data field for storing raw data.

19. The portable terminal of claim 13, wherein the connection unit comprises a wired module, selected from the group consisting of: 3.5 Φ Audio/Video (A/V) cable and a Universal Serial Bus (USB) port, or a wireless module of a short-distance wireless communication method, selected from the group consisting of: Bluetooth, Infrared Data Association (IrDA), Wireless Local Area Network (WLAN), and Shared Wireless Access Protocol (SWAP).

20. A method of transmitting an image file to the outside in a portable terminal of an image data processing system, the method comprising the steps of:
capturing an image using a camera;
generating raw data and preview data by converting an optical signal of the captured image to a digital signal and compressing and storing the raw data and the preview data; and
transmitting data of the captured image as an image file consisting of at least the stored raw data.

21. The method of claim 20, further comprising the step of:
decompressing the stored preview data, performing image processing of the decompressed preview data, and displaying the image-processed preview data as a preview image.

22. The method of claim 20, wherein the preview data is generated by sub-sampling the raw data by an amount of data required to display the captured image on a display unit of the portable terminal.

23. The method of claim 20, wherein the raw data is losslessly compressed and the preview data is lossy compressed.

24. The method of claim 20, wherein the image file is transmitted to the outside via cable or in a wireless manner.

25. The method of claim 20, wherein the image file comprises a header field for storing information on the image file, a preview data field for storing preview data, and a raw data field for storing raw data.

26. The method of claim 25, wherein the information on the image file contains information indicating that a current file is an image file, a total size of the image file, the size of the stored preview data, and the size of the stored raw data.

27. A portable terminal device comprising:
a processor in communication with a memory, the processor executing computer code causing the processor to execute the steps of:
receiving raw data and preview data of an image;
compressing and storing the raw and preview data; and
transmitting at least the raw data to an external device via a transmission medium.

28. The device of claim 27 wherein the preview data is generated by sub-sampling the raw data at a known rate.

29. The device of claim 27, wherein the raw data is losslessly compressed, and the preview data is lossy compressed.

30. The device of claim 27, wherein the transmitted data comprises a header field for storing information on the raw data.

31. The device of claim 27, the processor further executing computer code causing the processor to execute the steps of:
transmitting the preview data.

32. The device of claim 31, wherein transmitted data comprises a header field comprises a preview data field for storing preview data.

33. The device of claim 27, wherein said transmission medium is selected from the group consisting of: wired and wireless.
